(19) United States
(12) Patent Application Publication
(10) Pub. No.: US 2003/0087740 A1
(43) Pub. Date: May 8, 2003

(54) Method of and apparatus for manipulating running webs of paper and the like

(76) Inventors: Bernhard Brinkmann, Bornsen (DE); Frank Grothaus, Hamburg (DE); Martin Paech, Tespe (DE)

Correspondence Address: VENABLE, BAETJER, HOWARD AND CIVILETTI, LLP, P.O. BOX 34385, WASHINGTON, DC, 20043-9998, US

(21) Appl. No.: 10/280,099

(22) Filed: Oct. 25, 2002

(30) Foreign Application Priority Data
Oct. 25, 2001 (DE) 101 52 162.6

(51) Int. Cl. B31B 1/04

(52) U.S. Cl. 493/147

(57) ABSTRACT

A web of tipping paper for the making of filter cigarettes or a similar web of flexible wrapping material is advanced by two spaced-apart pairs of driven rolls through a processing station between the two pairs of rolls. The treatment includes flexing successive increments of the running web by a roller which is borne by a lever or an analogous carrier extending radially from the rotary output shaft of a torque motor capable of causing the roller to subject the web to an at least substantially constant stretching force regardless of the selected position of the carrier. To this end, the motor receives signals from a regulator which, in turn, receives signals from a sensor monitoring the web for the presence of splices and/or other weakened portions and/or from a device which monitors the position of the carrier. The apparatus can further comprise a stationary or a mobile curling tool which engages the web adjacent to the locus of contact between the roller and the web.

### CROSS-REFERENCE TO RELATED CASES

The present application claims the priority of the corresponding German patent application Serial No. 101 52 162.6 filed Oct. 25, 2001. The disclosure of the aforesaid German patent application, as well as the disclosure of each US and foreign patent and patent application identified in the specification of the present application, are incorporated herein by reference.

### BACKGROUND OF THE INVENTION

The present invention relates to improvements in apparatus for and in methods of treating running strips or webs (hereinafter called webs) of flexible material, such as webs of paper, artificial cork or the like. The webs which are treated in accordance with the method and in the apparatus of the instant invention can be utilized with advantage in connection with the making of smokers' products, e.g., filter cigarettes and analogous commodities wherein one or more rod-shaped filter mouthpieces are combined with coaxial plain cigarettes, cigars, cigarillos and analogous rod-shaped tobacco-containing products.

It is known to advance a running web of so-called tipping paper (such as relatively stiff paper or lightweight cardboard, artificial cork or the like) through a station provided in a tipping machine wherein one or more rod-shaped mouthpieces or filter plugs containing rod-shaped fillers of a material capable of intercepting tar, nicotine and/or other harmful ingredients of tobacco smoke are united with rod-shaped tobacco-containing products, e.g., with plain cigarettes. The running web of tipping paper (e.g., cigarette paper and/or artificial cork) is normally treated (such as flexed) by a so-called curling device or tool prior to or subsequent to subdivision into a series of discrete so-called uniting bands which are ready to be draped around neighboring ends of filter plugs and rod-shaped tobacco-containing products to form therewith filter-tipped smokers' products of unit length or multiple unit length. Reference may be had, for example, to commonly owned U.S. Pat. No. 5,135,008 granted Aug. 4, 1992 to Oesterling et al. for “METHOD OF AND APPARATUS FOR MAKING FILTER CIGARETTES”. This patent shows and describes in detail an apparatus wherein filter mouthpieces of double unit length are united with pairs of coaxial plain cigarettes of unit length to form therewith filter cigarettes of double unit length. Each such intermediate product is severed midway across the convoluted uniting band (i.e., midway across the filter mouthpiece of double unit length) to yield two discrete filter cigarettes of unit length. For example, the curling device can be installed adjacent that portion of the path of movement of a running web of tipping paper which is located ahead (upstream) of a paster serving to apply a film of suitable adhesive to one side of the running web of tipping paper.

The curling device subjects successive increments of the running web to the action of a force which can enhance the flexibility of the web, i.e., the facility of converting successive discrete uniting bands into tubular envelopes each of which attaches one end portion of a single plain cigarette to an end portion of a single filter mouthpiece or each of which completely surrounds a filter mouthpiece and the adjacent end portions of two discrete plain cigarettes of unit length. The magnitude of the transversely oriented deflecting force which is being applied to successive increments of the running web of tipping paper is or can be regulated in order to impart to the web a required flexibility and/or to avoid undue tensioning, e.g., of splices which connect successive elongated sections of a composite running web to each other. As a rule, the splices constitute weakened portions of a composite (multi-section) web so that excessive tensioning of a splice can lead or is bound to lead to a break and ensuing prolonged stoppage of a machine which is normally set up to turn out huge quantities of filter cigarettes, cigars, cigarillos and analogous smokers' products per unit of time.

Tubular envelopes of rod-shaped filter mouthpieces for tobacco smoke can also be made of a wrapping material which can or should undergo a treatment in a machine employing a curling device and/or an analogous arrangement for enhancing the flexibility of a running web which is to be draped around filter material for tobacco smoke. Regardless of its intended use, a web consisting of a material for use as a tipping paper or an envelope for plugs or rods of filter material or smokable material is normally drawn off a bobbin or reel, e.g., by being compelled to advance through the nip(s) of one or more pairs of driven rollers or drums. The curling device can include or constitute an elongated mobile part having a more or less pronounced edge which extends transversely of the path for and contacts successive increments of one side of the running web.

As already mentioned hereinbefore, the curling device can be installed ahead of a paster which coats one side of the running web with a film of suitable adhesive, and such paster is followed by a cutter which severs the running web at regular intervals to thus produce a series of successive (discrete) uniting bands of requisite length. The cutter is or can be omitted if the web is to be draped around a continuous rod or around an analogous body of filter material or tobacco to constitute an elongated tubular envelope of a continuous filter rod, cigarette rod of the like.

The station which is preceded by a curling device need not necessarily serve (or serve exclusively) to subdivide a running web of paper or the like into uniting bands for use in a filter cigarette making or an analogous machine. For example, such station can accommodate instrumentalities which serve to enhance or to uniformize the permeability of a running web of cigarette paper or other webs of strip-like material. In addition or alternatively to influencing the permeability, the station which is preceded by or accommodates a curling device of the above outlined character can also serve to provide room for equipment which is designed to provide a running web of paper or the like with printed matter and/or with other indicia pertaining to the identity and/or trademark(s) of the manufacturer of commodities (such as smokers' products) containing portions of the treated web, instructions for use or proper storage of the products, the useful life of the products, the contents of the products and/or others.

The edge of the curling device can resemble the cutting edge of a knife, a blade or an analogous implement (reference can be had, for example, to the specification and to the drawing of the U.S. Pat. No. 3,996,842 granted Dec. 14, 1976 to Ehlich et al. for “APPARATUS FOR REDUCING AND EQUALIZING LOCALIZED STRESSES IN RUNNING PAPER WEBS OR THE LIKE”). In many instances, the relatively sharp edge of the curling device causes the running web to curl or to exhibit a tendency to curl. The sharpness of the edge of the knife-like curling tool must be selected with a view to avoid excessive stressing of the material of the web, at least during certan critical stages, for example, during abrupt or reasonably rapid acceleration of the web from zero speed or from a lower speed to a higher speed, and/or when the curling device is approached by a relatively weak (such as spliced) portion of a (composite) web.

Attempts to avoid excessive stressing of relatively weak portions of a running web or of all portions of a web which can stand only limited tensional stresses include the utilization of one or more rotary tensioning devices, such as idler rollers extending transversely of a selected portion of the path for a running web of tipping paper or other sheet-like material. In many instances, the idler roller (also called dancer roller) is rotatably mounted at one end of a carrier, such as a lever or an arm of a lever, and the other end of such carrier is pivotable about an axis which is or which can be parallel to the axis of the roller. The extent of pivoting of the roller about such axis determines the magnitude of the deflecting force which the roller applies to the running web, i.e., the extent of tensioning of the web. Resilient means can be utilized to bias the arm, i.e., to yieldably urge the roller against one side of the running web. Dancer rollers of the just outlined character and the supporting and moving means therefor are disclosed, for example, in German patent No. 40 08 475 A1.

Curling devices of the above outlined character and the means for mounting, moving and/or otherwise manipulating such curling devices are particularly important in many types of tobacco processing machines. It has been ascertained that the utilization of a properly treated flexible wrapping material for rod-shaped tobacco-containing products, for filter mouthpieces and/or for combinations of such commodities exerts a pronounced influence upon their quality (including their appearance). Thus, not only the shape of a curling device (e.g., a device employing or constituting a knife-like implement and/or a roller-shaped web-contacting tool) but also the manner of guiding, driving, dimensioning and/or otherwise manipulating the curling device can exert a pronounced influence upon the quality, appearance and/or other characteristics of the ultimate product(s). The just enumerated prerequisites are or can be just as important as, or perhaps even more important than, the quality of the web, the nature of mounting the bobbins of convoluted web, the nature of braking mechanism(s) for the bobbin or bobbins and/or the nature of splicing means which is employed to join successive sections of a composite web end-to-end.

German patent No. 199 28 867 A1 discloses an apparatus which is designed to transport a web of flexible sheet material for use in the tobacco processing industry wherein the web is advanced lengthwise by two pairs of rolls which are spaced apart from each other, as seen in the longitudinal direction of the path for the advancing web lengthwise from the source (such as a bobbin) toward, past and/or beyond one or more treating or processing stations. The first pair of advancing rolls feeds the web into a magazine of the type customary in many tobacco processing machines, namely into a storage facility wherein the web is alternatively looped around successive deflecting rolls of two rows of normally closely adjacent rolls defining a meandering portion of the path which can store a substantial length of the web in a small-area. The second pair of advancing rolls draws the leader of the web from the storage facility and past a curling device including a knife-like implement. A deflecting roller is installed between the outlet of the storage facility and the curling device; this roller has a perforated peripheral surface surrounding a suction chamber which attracts successive increments of the web to the peripheral surface with a variable force. The force is regulated by controlling the subatmospheric pressure in the suction chamber, i.e., the web can be attracted with a constant force to ensure that it is or that it can be attracted to the roller with a desired force. Otherwise stated, by regulating the pressure (and more particularly the subatmospheric pressure) in the roller, the patented apparatus can determine the magnitude of the force with which the running web is pulled away from the storage facility.

A drawback of the aforedescribed conventional methods and apparatus is that they lack the desired or required versatility, that the elimination of one problem often generates other problems, that such conventional apparatus are too bulky and/or too complex, and/or that they cannot be readily installed in and/or combined with existing machines which employ and/or process webs of tipping paper, lightweight cardboard, artificial cork and/or other flexible wrapping and/or other materials.

### OBJECTS OF THE INVENTION

An object of this invention is to provide an apparatus which constitutes an improvement over the aforedescribed conventional web treating apparatus, especially as concerns the reliability, reproducibility and adjustability of the application of tensional stresses to a running web of paper, cardboard, artificial cork and/or the like.

Another object of the invention is to provide an apparatus which can be utilized with advantage in existing machines and/or production lines for the processing of running webs of paper or the like, such as in filter cigarette making machines, imprinting machines, perforating machines and others.

A further object of our invention is to provide an apparatus which can automatically react to detection of weakened portions or parts of a running web to thus prevent or greatly reduce the likelihood of tearing of the web.

An additional object of the invention is to provide an apparatus of the above outlined character with novel and improved means for contacting, tensioning and/or otherwise treating a continuous running web, particularly in a machine for the making of rod-shaped smokers' products.

Still another object of the invention is to provide a novel and improved method of manipulating a running web of paper or the like in a machine for the making and/or processing of rod-shaped smokers' products.

A further object of the invention is to provide a novel and improved method of regulating tensioning forces which are being applied to a running web of paper, artificial cork or the like.

An additional object of the invention is to provide a novel and improved curling device or tool for use in apparatus which are designed to treat running webs of tipping material or the like.

Another object of the invention is to provide a novel and improved machine for making rod-shaped products, such as smokers' products, tampons and the like.

Still another object of the invention is to enhance the quality, including the appearance, of rod-shaped products, particularly those wherein a tubular wrapper surrounds one or more rod-shaped fillers or cores of tobacco, filter material for tobacco smoke and/or others.

### SUMMARY OF THE INVENTION

One feature of the present invention resides in the provision of an apparatus for manipulating a running elongated web of flexible material, such as cigarette paper, tipping paper or the like. The improved apparatus comprises means for advancing the web lengthwise in a predetermined direction along a predetermined path through a processing station (such advancing means can comprise two pairs of driven advancing rolls defining nips for the passage and entrainment of the web), a roller or other suitable means for deflecting successive increments of the running (advancing) web at the processing station to a variable degree transversely of a portion of the path with attendant flexing of the web, means for moving the deflecting means (hereinafter called roller for short) between a plurality of different positions (such moving means can include a torque motor constituting a means for applying to the roller a variable force), and means for maintaining the force at an at least substantially constant value irrespective of the position of the roller relative to the runing web.

The web can consist of cigarette paper, tipping paper (such as artificial cork) or another wrapping material for smokers' products.

The aforementioned motor is regulatable, and the means for maintaining the force at an at least substantially constant value irrespective of the position of the roller relative to the running web can include means (such as an electronic regulator or regulating unit) for regulating the motor with a view to ensure that the magnitude of the variable force upon and the position of the roller are variable independently of each other to at least approximate predetermined values.

Since the web normally includes (or is likely to include) randomly distributed irregularities (such as splices and/or other types of weakened portions), the aforementioned maintaining means preferably further comprises sensor means adjacent to the path of the running web and serving to generate signals in response to detection of irregularities. The regulating means is then operative to effect a reduction of the web-tensioning force in response to signals from the sensor means.

The roller is movable between at least one operative position of engagement with and at least one inoperative position of disengagement from the running web, and the moving means is or can be arranged to move the roller to the inoperative position in response to signals from the sensor means.

The rolls of at least one pair of the aforementioned advancing rolls are adapted to be driven at a plurality of different speeds, and the aforementioned regulator can comprise means for regulating the speed of the at least one pair of advancing rolls as a function of the position of the roller, i.e., in dependency upon the extent of tensioning of the web.

In accordance with a presently preferred embodiment, one pair of web advancing rolls is installed upstream of the processing station, and the other pair of advancing rolls is installed downstream of such station. The rolls of the first and second pair are arranged to respectively advance the web at different first and second speeds, and the regulator can be arranged to vary the speed of the at least one pair of rolls and hence (when necessary) the difference between the speeds of the first and second pairs of rolls as a function of changes in the position of the roller relative to the running web.

The means for maintaining the force at an at least substantially constant value can include means for establishing a reference value as a function of the position of the roller.

The positions of the roller can include at least one position in which the deflecting force being applied to the running web is at least close to zero.

The advancing means is or can be arranged to advance the web at a plurality of speeds including zero speed, and the positions of the roller can include an idle position in which the roller is at least substantially disengaged from the web. The moving means of such apparatus can include means for effecting a movement of the roller to its idle position in response to each reduction of the speed of the web to zero speed. Such moving means can include an electric motor which is arranged to be disconnected from its energy source when the roller is at least substantially disengaged from the running web.

The means for moving the roller can include a torque generator (such as a torque motor) which is arranged to transmit an at least substantially constant torque.

The arrangement can be such that the roller is movable along an arcuate path, and the moving means then comprises a motor which is arranged to move the roller along such arcuate path. The center of curvature of the arcuate path can be on the axis of the rotary output element of the motor.

If the deflecting means includes or constitutes an idler roller, such idler roller can be carried by a support (such as a lever) which is non-rotatably mounted on the output element of the motor. The arrangement can be such that a first end portion of the lever is affixed to the output element of the motor and the idler roller is mounted on a second end portion of the lever which is remote from the first end portion. The lever can extend at least substantially radially of the output element of the motor.

The roller is arranged to contact one side of the running web, and the improved apparatus can further comprise a curling tool which can be provided with an edge extending transversely of the path of the web at the processing station and contacting the other side of the running web, at least when the one side of the web is contacted by the roller and the latter flexes the web.

The curling tool can be mounted (and/or the direction of movement of the web can be selected) in such a way that the curling tool contacts the running web upstream or downstream of the roller (as seen in the direction of advancement of the web).

The curling tool can be operatively connected to and is then movable with the roller in synchronism with the roller. As already mentioned hereinbefore, the positions of the roller can include a position in which the magnitude of the deflecting force being applied by the roller to the adjacent side of the web is at least close to zero; the curling tool is preferably out of contact with the web in such position of the roller.

The aforesaid support on the output element of the motor for moving the roller along an arcuate path can mount the roller as well as the curling tool. The axis of the curling tool can at least substantially coincide with the axis of the rotary output element of the motor. Still further, the mounting of the curling tool can be such that its cutting edge coincides (at least substantially) with the axis of the output element of the motor.

The curling tool can be fixedly (non-rotatably) or rotatably mounted on its support; the latter can include a portion which is remote from the roller and rotatably or non-rotatably mounts the curling tool.

It is also possible to employ a curling tool which is stationarily mounted at the processing station and separate from the support. The moving means is then arranged (or can be arranged) to move the deflecting means relative to the curling tool.

It is often advisable to provide the improved apparatus with a calibratable device which monitors the positions of the roller and with means for calibrating such device; the calibrating means can form part of the means for maintaining the variable force at a substantially constant value and can include means for effecting movements of the roller between a first position of disengagement from the running web and a second position of maximum deflection of the web.

Another feature of the present invention resides in the provision of a method of regulating the tensioning of a running elongated web of flexible material, such as cigarette paper, tipping paper of the like. The method comprises the steps of advancing the web lengthwise in a predetermined direction and along a predetermined path, and moving successive increments of the running web to a variable degree transversely of a portion of such path with attendant flexing and tensioning of the web; the moving step includes applying to the web a force which acts upon one side of the web, and the method further comprises the step of maintaining the aforementioned force at an at least substantially constant value irrespective of the extent of movement of successive increments of the web away from the aforesaid portion of the predetermined path for the web.

The novel features which are considered as characteristic of the invention are set forth in particular in the appended claims. The improved apparatus itself, however, both as to its construction and the modes of assembling, installing and operating the same, together with numerous additional important and advantageous features and attributes thereof, will be best understood upon perusal of the following detailed description of several presently preferred specific embodiments with reference to the accompanying drawing.

### BRIEF DESCRIPTION OF THE DRAWING

FIG. 1 is a schematic elevational view of an apparatus which embodies one form of the present invention and wherein a running web of flexible material can be contacted, tensioned and otherwise treated by a rockable roller as well as by a rockable knife-like curling tool;

FIG. 2 is an enlarged perspective view of a portion of the apparatus which is shown in FIG. 1;

FIG. 3 illustrates the structure of FIG. 2 but with the roller and the curling tool disengaged from the web;

FIG. 4 is a perspective view of a modified apparatus which employs a fixedly mounted curling tool and a rockable tensioning roller, with the latter shown in one of its operative positions;

FIG. 5 shows the structure of FIG. 4 but with the roller in the inoperative position; and

FIG. 6 is a schematic perspective view of a third apparatus which operates without a knife-like curling tool, the roller being shown in the operative position.

### DESCRIPTION OF PREFERRED EMBODIMENTS

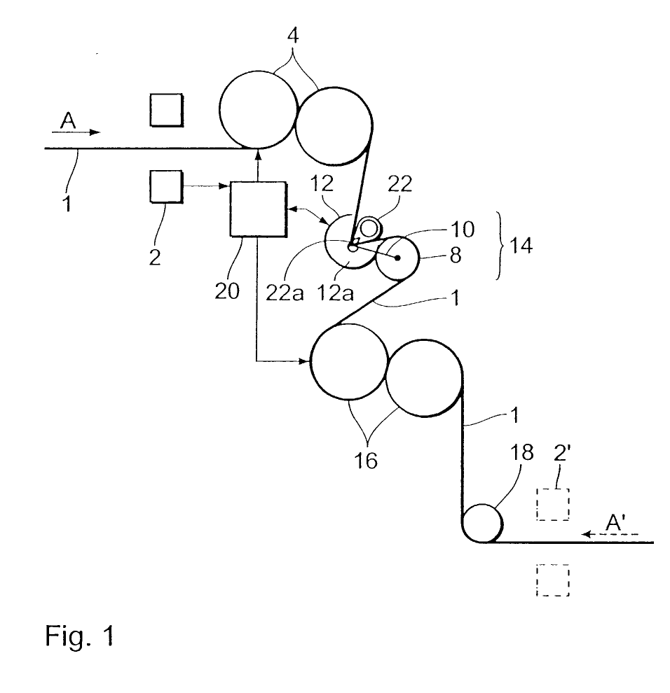

FIG. 1 shows an apparatus which is designed to treat a continuous running web 1 of flexible material, e.g., tipping paper which is processed in a filter cigarette making machine (called tipping machine), e.g., a machine known as “MAX” and distributed by the assignee of the present application. The properly treated web 1 is assumed to enter a severing device which converts the web into a series of discrete uniting bands serving to join filter mouthpieces and rod-shaped tobacco-containing sections end-to-end. Reference may be had, for example, to the aforementioned U.S. Pat. No. 5,135,008 to Oesterling et al. which shows a tipping machine wherein uniting bands are employed to form filter cigarettes of double unit length. Each such cigarette contains two spaced-apart coaxial plain cigarettes of unit length, a filter mouthpiece of double unit length between the two plain cigarettes, and an adhesive-coated tubular wrapper (convoluted uniting band) which surrounds the entire filter mouthpiece as well as the adjacent end portions of the two plain cigarettes. It will be appreciated that a filter tipping machine is but one of a variety of machines which can employ or cooperate with the apparatus of FIG. 1 or an analogous apparatus embodying the present invention.

The apparatus of FIG. 1 employs a web advancing arrangement including a first pair of driven rolls 4 and a second pair of driven rolls 16. The web 1 arrives from a source (e.g., a bobbin or reel, not shown) toward and into the nip of the advancing rolls 4 (see the arrow A) and is advanced along an elongated path toward and into the nip of the advancing rolls 16. In that portion of its path which extends from the rolls 4 to the rolls 16, the web 1 is normally treated (tensioned) by a deflecting means 8 here shown as a dancer roller and is normally further treated by the relatively sharp (pronounced) edge 22a of a curling tool 22 in the region immediately preceding the establishment of contact between one side of the running web and the peripheral surface of the roller 8. The parts 8 and 22 are or can be installed in a frame or housing (not shown) located at a treating or processing station 14.

The character 2 denotes in FIG. 1 a sensor which monitors successive increments of the running web 1 for the presence of defects (weakened portions) such as splices serving to bond successive sections of the web to each other. The sensor 2 transmits signals to a regulating unit or regulator or control unit 20 which, among other functions, can regulate the RPMs of the advancing rolls 4 and 16. On their way from the bobbin, successive increments of the running web 1 advance (in the direction of arrow A) past the sensor 2, through the nip of the advancing rolls 4, through the processing station 14, and toward and through the nip of the advancing rolls 16. The rolls 16 are followed by a deflecting roller 18 which directs the web 1 toward a further processing station (not shown) wherein one side of the web can be coated with a suitable adhesive prior to entry into a severing device which divides the web into a series of discrete uniting bands ready to be convoluted around two or more coaxial rod-shaped products, e.g., in a manner as disclosed in the aforementioned U.S. Pat. No. 5,135,008 to Oesterling et al.

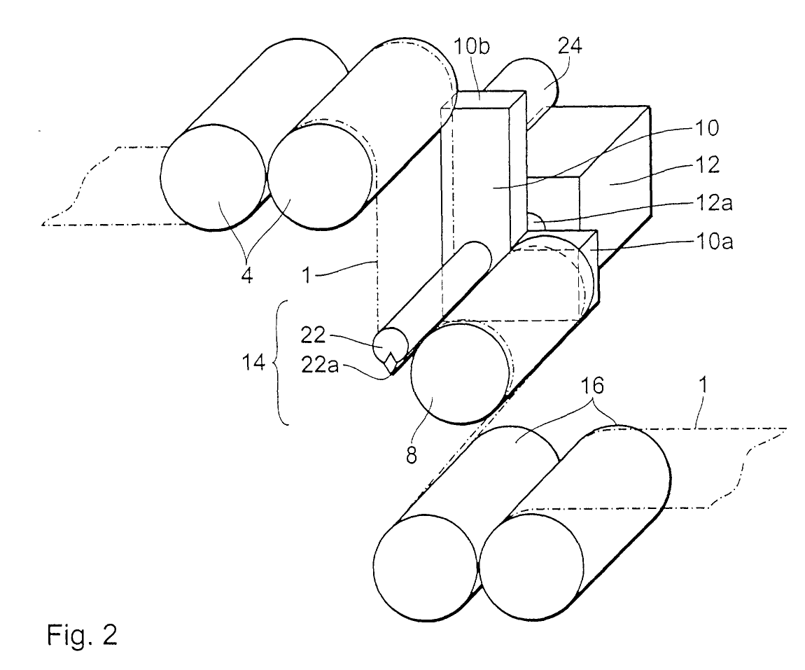

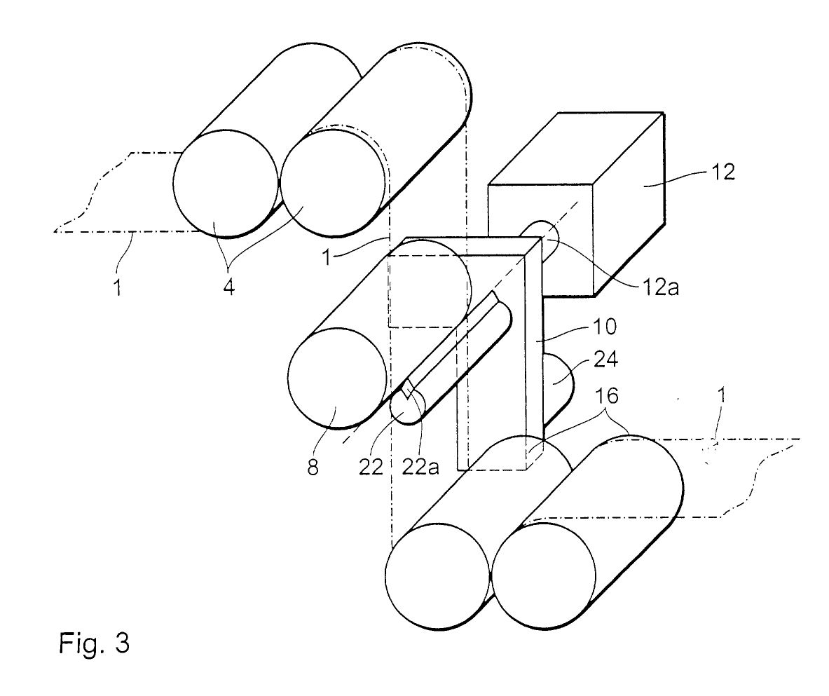

FIG. 2 shows in greater detail the manner in which the web 1 is treated at the processing station 14 between the two pairs of advancing rolls 4 and 16. The sensor 2 and the deflecting roller 18 of FIG. 1 are omitted. As they advance beyond the rolls 4, successive increments of the running web 1 are engaged by the relatively sharp transversely extending edge 22a of the preferably cylindrical curling tool 22. The edge 22a coincides with the axis of the output shaft 12a of the torque motor 12. The tool 22 is non-rotatably (fixedly) mounted on one arm 10a of an L-shaped twin lever 10 which is mounted on and can be turned by the output shaft 12a (i.e., by the motor 12) so that the roller 8 can be moved along an arcuate path between the idle or retracted position of FIG. 3 (in which a flat portion of the running web 1 extends from the nip of the advancing rolls 4 to the nip of the advancing rolls 16) and that one of a plurality of different operative positions which is illustrated in FIG. 2. The axis of the output shaft 12a (and hence the edge 22a of the curling tool 22) is parallel to and spaced apart from the axis of the roller 8.

The arm 10b of the lever 12 carries at least one counterweight 24 which moves the roller 8 to the retracted position of FIG. 3 when the motor 12 is off. The latter can constitute an electric motor.

It will be noted that the parts 8 and 22 constitute a structural unit. The curling edge 22a faces downwardly or to the left when the unit including the parts 8, 22 is in use (see FIGS. 1 and 2) but upwardly (see FIG. 3) when the roller 8 cannot deflect the running web 1 and the latter is not contacted by the edge 22a. A comparison of the angular positions of the lever or support or carrier 10 shown in FIGS. 2 and 3 indicates that, in this embodiment of the improved apparatus, the output shaft 12a must be turned through 180° in order to move the parts 8, 22 from the inoperative positions of FIG. 3 to the fully operative positions of FIG. 1 or 2. When in such fully operative position, the roller 8 causes maximum deflection of the adjacent portion of the web 1 from that position in which such portion of the web is straight all the way from the advancing rolls 4 to the advancing rolls 16. The arrangement in the embodiment of FIGS. 1 to 3 is such that the edge 22a contacts and flexes the web 1 only when the roller 8 is caused to leave the inoperative position of FIG. 3 and an arcuate portion of its cylindrical peripheral surface is contacted by the adjacent side of the running web.

The operation of the motor 12 is controlled by the regulator 20. The arrangement is such that the output shaft 12a of the motor 12 transmits a constant torque to thus maintain the parts 8, 22 in predetermined angular positions. The magnitude of the torque determines the extent of angular movement of the lever 10 from the idle or inoperative or starting position of FIG. 3, i.e., the magnitude of the tensioning force being applied to and acting longitudinally of the running web 1.

The regulator 20 controls the motor 12 in such a way that the torque being generated by the motor is caused to assume a predetermined value, i.e., that the magnitude of the torque is not dependent upon the angular position of the lever 10.

As already mentioned hereinbefore, the regulator 20 further controls the RPMs of the advancing rolls 4 and 16. As a rule, the RPM of each of the downstream advancing rolls 16 exceeds the RPMs of the upstream advancing rolls 4. This already entails a certain tensioning of the running web 1. The regulator 20 determines the difference between the RPMs of the pairs of advancing rolls 4 and 16 in dependency upon (i.e., as a function of) the angular position of the lever 10, i.e., upon the extent of contact between the peripheral surface of the roller 8 and the running web 1.

The regulator 20 includes or cooperates with a detector or sensor which monitors the angular position of the lever 10 and/or the angular position of the output shaft 12a of the motor 12. It is assumed that, in the embodiment of FIGS. 1 to 3, the detector is part of the motor 12. In order to properly calibrate the detector (when the apparatus is started or is to be started), the regulator 20 controls the motor 12 in such a way that the lever 10 is first moved to the (idle) position of FIG. 3 and thereupon to the fully operative end position of FIG. 2. To this end, the apparatus can be provided with suitable stops (not shown) one of which can arrest the lever 10 against movement beyond the preselected fully retracted angular position and the other of which can arrest the lever 10 against movement beyond the preselected fully extended position.

When the apparatus is at a standstill, the unit 20 regulates the motor 12 in such a way that the lever 10 is caused to assume the starting or idle position of FIG. 3. Furthermore, when the energy consuming components of the apparatus are disconnected from the energy source(s), the lever 10 remains in the idle position of FIG. 3. This allows for rapid and convenient removal of a remnant of a preceding web 1 and for the threading in of a fresh web or of a different web.

If the sensor 2 generates a signal denoting, for example, the detection of a splice while the web 1 is running, the regulator 20 receives an appropriate signal and causes the motor 12 to transmit a lesser torque. This, in turn, causes the roller 8 to reduce the bias upon successive increments of the running web 1 (i.e., to reduce the tensional stress upon the web). The importance of such arrangement will be appreciated by bearing in mind that a splice normally constitutes a weakened portion of the web, i.e., in the absence of an undertaking to the contrary, the web would be likely to break or tear in the region of the splice while the splice is in the process of advancing from the rolls 4 to the rolls 16. In addition, one must take into consideration the weight of the roller 8. For example, the strength or quality of the web 1 can be selected in such a way that the web can readily stand a tensional stress in the range of about 7 N; on the other hand, the resistance which a splice normally offers to tearing (this term is intended to encompass separation of the two spliced-together ends of two successive webs) is or can be in the range of about 0.5 N. Assuming that the weight of the roller 8 contributes additional 2 N to the stressing of the spliced-together composite web, the overall force to be applied in normal operation of the improved apparatus is about 9 N but only about 2.5 N when a splice is located between the two pairs of advancing rolls 4 and 16. This can be readily achieved by resorting to a torque-regulated motor 12.

In accordance with a modification (e.g., in the event of a different distribution of the weights), the torque to be applied upon detection of a splice or another weakened portion or imperfection of the web must change its sign. Thus, during a reduction of torque being furnished by the motor 12, i.e., during a reduction of tensional stress upon the running web 1, the regulation of the position of the lever 10, and hence also of the position of the roller 8, can be interrupted or turned off, namely for an interval of time which is required for the advancement of the splice or an analogous weakened portion of the web beyond the nip of the downstream (second) advancing rolls 16.

FIG. 2 shows the aforementioned counterweight 24 which is mounted on the longer arm 10b of the lever 10 and the main purpose of which is to cause the lever 10 to pivot under the action of gravity in response to deactivation of the motor 12 so that the parts 8 and 22 automatically assume the idle positions shown in FIG. 3. The parameters of the counterweight 24 can be readily selected in such a way that its weight furnishes a predetermined force which opposes the torque being generated by the motor 12 in normal operation of the improved apparatus. The single counterweight 24 can be replaced with a plurality of such parts.

FIGS. 1 and 2 show that, when the apparatus is in use, the edge 22a of the curling tool 22 is located ahead (upstream) of the locus of contact between the roller 8 and one side of the running web 1 (i.e., as seen in the direction of arrow A). However, it is equally within the purview of the invention to reverse the direction of advancement of the web 1 (see the arrow A′ in FIG. 1); the sensor 2 is replaced with or provided in addition to a sensor 2′, and the roller 8 then engages one side of the web upstream of the elongated edge 22a of the tool 22.

An advantage of the arrangement which is shown in FIG. 1 by solid lines is that one can directly regulate the tensonal stress which is furnished by the roller 8 and determines the curling action upon the material of the web as applied by the edge 22a of the tool 22.

If the web 1 is advanced in the direction of the arrow A′, i.e., if the roller 8 is installed upstream of the edge 22a of the tool 22, a reduction of torque being applied by the (then) downstream advancing rolls 4 can be monitored to constitute an indicator of the quality (extent of sharpness or dullness) of the edge 22a of the curling tool.

The required or desired position of the roller 8, and hence the angle enclosed by the web portions flanking the edge 22a of the curling tool 22, can be monitored and compared with a predetermined desired or required angle to indicate the quality of operation of the improved apparatus.

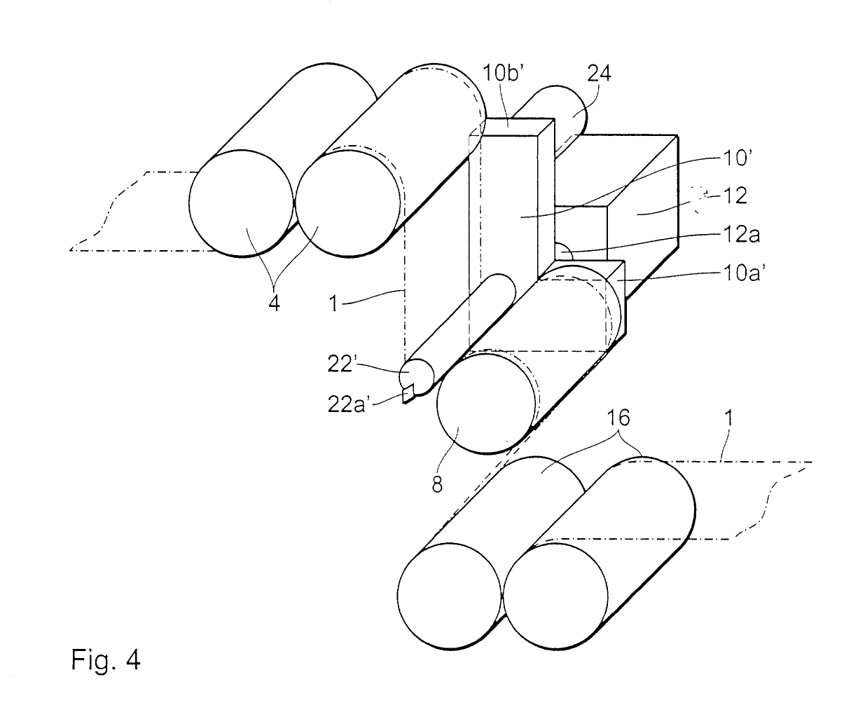

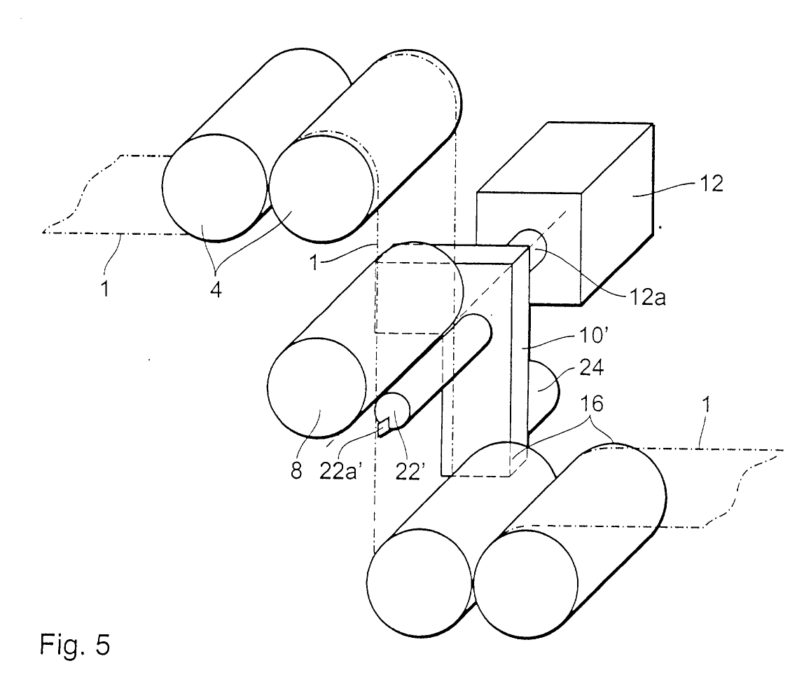

The apparatus which is shown in FIGS. 4 and 5 constitutes a presently preferred embodiment and differs from the apparatus of FIGS. 1 to 3 in that it employs a stationary curling tool 22′ having an elongated relatively sharp or pronounced edge 22a′ extending transversely of the path of the running web 1 between the nips of the pairs of advancing rolls 4 and 16. To this end, the tool 22′ is not mounted on the lever (carrier or support) 10′ for the floating or dancer roller 8 but rather on a stationary support (not shown). The motor 12 again serves as a means for moving the roller 8 relative to the straight path for the web 1 between the pairs of advancing rolls 4 and 16. Furthermore, the motor 12 serves to move the roller 8 and its support (lever) 10′ relative to the curling tool 22′.

FIG. 4 shows the roller 8 in the operative position in which the roller engages and deflects a portion of the running web 1 at the edge 22a′ of the curling tool 22′. In FIG. 5, the roller 8 is inoperative, i.e., it permits successive increments of the running web 1 to advance along a straight path all the way from the deflecting rolls 4 to the deflecting rolls 16. Such increments are or can be at least slightly spaced apart from the edge 22a′ of the stationary tool 22′. It is often preferred to install the tool 22′ in such a way that it is at least slightly spaced apart from the running web 1 when the roller 8 assumes the idle or retracted or inoperative position of FIG. 5. At such time, the roller 8 is also spaced apart from the straight path for the web 1 between the two pairs of advancing rolls 4 and 16 shown in FIG. 5; this straight path exends between the deflecting roller 8 and the curling tool 22′.

As concerns the mode of operation of the unit which regulates the motor 12 which, in turn, pivots the lever 10′ for the roller 8 of FIGS. 4 and 5, and the monitoring means or sensor(s) which transmits or transmit signals to the regulating unit, reference should be had to FIGS. 1 to 3 and to their description in the preceding passages of this specification. Any differences which might exist between the aforedescribed controls of the apparatus of FIGS. 1 to 3 and those of the apparatus shown in FIGS. 4 and 5 are or can be of a nature well within the skill of the proverbial man possessing the necessary knowledge expected from those active in the field to which the present invention pertains.

It will be appreciated that the working or processing station 14 shown in FIGS. 1 to 3 and the working stations in other embodiments of the improved apparatus can be utilized to prepare the web 1 for use as a means for furnishing uniting bands in filter cigarette making or other tobacco and/or filter material processing machines, as well as for other uses, e.g., to deliver the properly tensioned and curled web to a unit which serves to change (such as increase) the permeability of the web by providing it with perforations, to provide the web with printed matter and/or to subject the web to other types of treatment. For example, the web advancing beyond the rolls 16 shown in FIGS. 1 to 5 can be caused to enter a machine of the type disclosed in U.S. Pat. No. 4,281,670 (granted Aug. 4, 1981 to Heitmann et al. for “APPARATUS FOR INCREASING THE PERMEABILITY OF WRAPPING MATERIAL FOR ROD-SHAPED SMOKERS' PRODUCTS”) wherein a running web of cigarette paper or the like is perforated by one or more laser beams. A running web of cigarette paper can be provided with printed matter denoting the name of the manufacturer, the trademark(s) of the smokers' products and/or other information. Furthermore, a properly curled web of wrapping material for smokers' products, other rod-shaped products or the like can be treated in a manner as shown and described in the present application and is then ready to be caused to advance through a perforating unit as well as through a printing unit prior to being delivered to the unit which converts the web into tubular or otherwise configurated envelopes or the like.

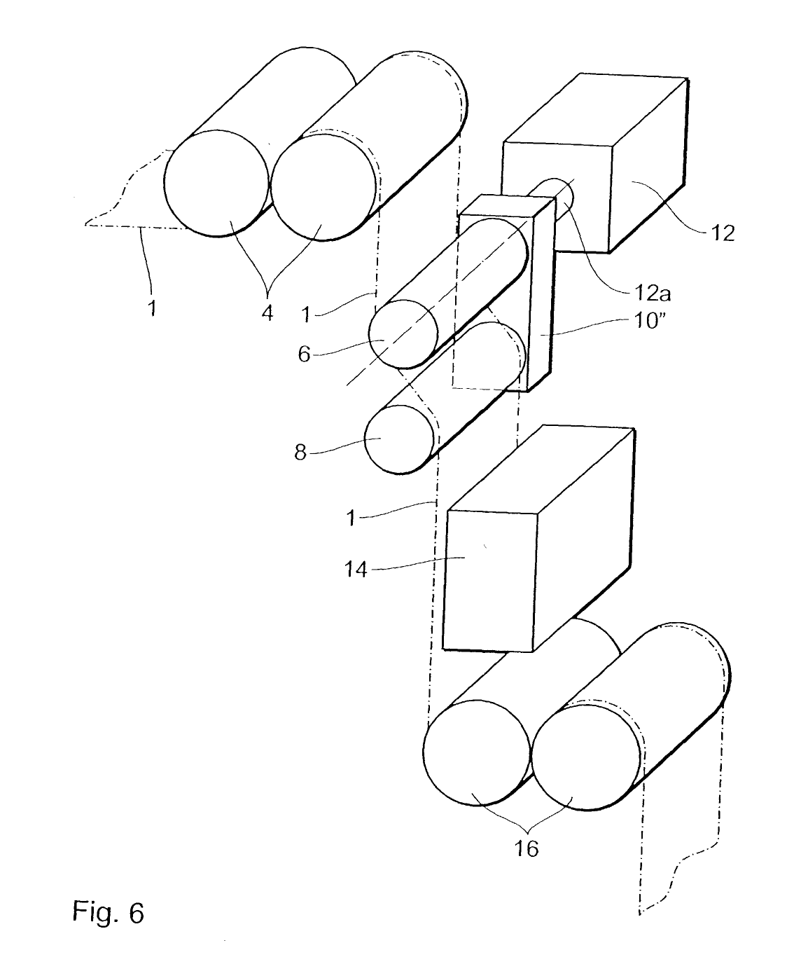

FIG. 6 illustrates certain details of an apparatus which does not employ a curling tool. The deflecting roller 8 is mounted on a simple radially extending lever 10″ adapted to be caused to turn about the axis of the output shaft 12a of a motor 12, e.g., an electric motor. The roller 8 is turnable relative to the lever 10″ about its axis which is parallel to the axis of an idler roller 6. The latter is also mounted on the lever 10″ and is coaxial with the output shaft 12a of the motor 12. The idler roller 6 can be said to constitute a substitute for the curling tool 22 or 22′.

The treating station 14 of FIG. 6 contains or includes means for subjecting the web 1 to a different treatment. For example, the station 14 of FIG. 6 can accommodate means for perforating the web 1 (e.g., in one of the several manners described and shown in the aforementioned U.S. Pat. No. 4,281,670 to Heitmann et al) and/or means for providing spaced-apart portions of the web with printed matter. Furthermore, the apparatus of FIG. 6 can utilize a deflecting roller corresponding to the roller 18 in the apparatus of FIG. 1.

Still further, the apparatus of FIG. 6 can employ a sensor corresponding to the sensor 2 and/or 2′ in the apparatus of FIG. 1. Moreover, the apparatus of FIG. 6 also employs a regulating unit which is or can be similar to, at least substantially identical with or analogous to the regulating unit 20 shown in FIG. 1.

The idler roller 6 in the apparatus of FIG. 6 does not or need not change its position when it is in use (as shown in FIG. 6) or when it is idle. The difference is that, when the lever 10″ is pivoted counterclockwise at a radial distance from the output shaft 12a of the motor 12, the web 1 is free to advance from the right-hand advancing roll 4 to the left-hand advancing roll 16 along a straight portion of its path and to bypass the idler roller 6, i.e., the web is then free to advance between the pairs of rolls 4 and 16 without even slightly contacting the roller 6 and/or 8.

The extent to which the motor 12 is caused to pivot the lever 10″ counterclockwise (to or even beyond the angular position shown in FIG. 6) determines the intensity of the curling action of the idler roller or tool 6 upon the running web 1. The curling action of this idler roller 6 is analogous to that exerted upon the web 1 by the roller 8 except that the parts 6 and 8 flex the running web in opposite directions, namely clockwise and counterclockwise as seen in FIG. 6.

An important advantage of all embodiments of the improved apparatus is that the unit 20 regulates the operation of the motor 12 in such a way that, when the apparatus is in use, the deflecting roller 8 is being acted upon by an at least substantially constant force independently of the position of the roller. This renders it possible to regulate the tensioning of the running web 1 with a view to ensure that the stretching force acting upon the web remains at a desired (selected) constant value.

Another important advantage of the improved apparatus includes its compactness, adaptability and versatility. The apparatus takes up a small amount of space and can be readily installed in existing machines wherein a web of paper or the like must be transported and subjected to further processing involving any one or two or more different treatments such as uniformizing its flexibility, detecting splices and/or other weakened portions, imprinting, altering its permeability and/or others. All that is necessary is to move the roller 8 from its retracted or inoperative position (see, for example, the position of the roller 8 as shown in FIG. 3) to its extended or operative position (such as that shown in FIGS. 1 and 2) in order to alter the configuration of that portion of the path for the web 1 which extends between the two pairs of advancing rolls 4 and 16.

It is often preferred to select the construction and the mode of operation of the combined monitoring and regulating means 2, 20 in such a way that the operation of the motor 12 can be controlled to ensure that the force which the motor applies to the support or lever 10, 10′ or 10″ for the roller 8 and the position of the roller 8 (and hence of the lever) can be regulated (to arrive at a desired or predetermined force and at a desired or predetermined position) independently of each other.

The sensor 2 exhibits the important advantage that it reduces the number of stoppages of the machine or machine part which processes the web issuing from the improved apparatus. Thus, signals from the sensor 2 enable the unit 20 to change the influence of the roller 8 and (if provided) curling tool 22 or 22′ upon the running web so that the web does not break or tear (or is less likely to tear) when a splice or another weakened portion of the web advances between the two pairs of advancing rolls 4 and 16. The regulating unit 20 then causes the motor 12 to reduce the force being applied to the web 1 by the roller 8 to a value or magnitude which is less than that of the normally applied force. Such reduction of the force being applied to the running web is particularly important when the improved apparatus employs a curling tool (such as 22 or 22′) because the edge of the tool subjects the web to the action of a pronounced force which is apt to cause a splice to open if the tensional stress upon the splice matches that upon a non-weakened portion of the web.

Though the improved apparatus can operate with a single pair of advancing rolls (e.g., with the advancing rolls 16 shown in FIGS. 1 to 3), it is normally preferred to employ several pairs of advancing rolls and/or analogous advancing means. An advantage of the feature that the regulating unit 20 can control the speed of at least one pair of web advancing rolls is that the RPMs of the thus controlled advancing rolls can be caused to depend upon the position of the roller 8. If (and as actually shown in FIG. 1) the unit 20 can regulate the RPMs of both pairs of advancing rolls 4, 16, this ensures that the difference between the RPMs of the rolls 4 and the RPMs of the rolls 16 is also a function of the position of the roller 8, i.e., a function of the extent to which the web 1 is flexed from the straight path extending from the rolls 4 to the rolls 16. As already mentioned hereinbefore, the RPMs of the downstream rolls 16 normally exceed the RPMs of the upsteam rolls 4, i.e., the rolls 16 bring about a stretching of the web 1 independently of that which is caused by the roller 8.

A predetermined desired or required value can be selected in dependency upon the condition of the means for positioning the parts 8,10 or 8,10′ or 8,10″.

When the roller 8 is moved to its retracted or inoperative position (see FIG. 3 or 5), the web 1 is not or need not be subjected to any, or any appreciable, tensional stresses. This preferably applies when the improved apparatus or the machine or production line embodying such apparatus is at a standstill. Such arrangement reduces the likelihood of unnecessary tensioning of the web.

The regulating unit 20 can be set up to prevent the motor 12 from causing a stretching and the attendant tensioning of the web 1 when the improved apparatus or the machine or production line employing the apparatus is idle. All that is necessary is that the motor 12 causes the roller 8 to become disengaged from the web 1 or to assume a position in which the web is not subjected to appeciable tensional stresses. If the motor 12 is an electric motor, this can be accomplished by disconnecting the motor from the source(s) of electrical energy. The same holds true if the machine embodying or cooperating with the improved apparatus is normally connected to one or more sources of electrical energy. Again, all that is necessary is to ensure that the roller 8 is caused or permitted or compelled to reduce or interrupt or terminate the tensioning of the web (as a result of disconnection of the motor 12 and/or the entire apparatus and/or the entire machine from the source(s) of electrical and/or other energy) when such tensioning is no longer required or can or must be interrupted for a certain interval of time. The counterweight 24 can serve to retain the roller 8 in the inoperative position as long as the motor 12 is off.

An advantage of the just discussed feature is that the apparatus is automatically ready for the introduction of the leader of a fresh web as soon as the roller 8 is permitted or caused to assume the inoperative position such as that shown in FIG. 3 or 5. In addition, the remnant of a partly or practically fully consumed (processed) web 1 can be readily withdrawn from the apparatus as soon as it is no longer engaged and tensioned by the roller 8.

An important advantage of the torque regulated motor 12 is that it can be set up to furnish an at least substantially constant torque. Such arrangement renders it possible to ensure a relatively simple but highly reliable regulation of tensional stressing of the running web so that the selected extent of stressing remains at least substantially unchanged for any desired interval of time and in any selected position of the roller 8. Such advantages cannot be achieved by resorting to a spring or a set of springs because the bias of a resilient element varies as a function of the extent of deformation. As already mentioned above, the motor 12 is preferably a torque-regulated torque motor.

The feature that the roller 8 is mounted on a lever (10, 10′ or 10″) at a distance from the axis about which the lever is caused to turn by the motor 12 exhibits the advantage that the extent of deflection of the web 1 from the straight path (shortest distance) between the pairs of advancing rolls 4 and 16 can be regulated with a high degree of accuracy and reproducibility. Furthermore, the angular position of the lever 10, 10′ or 10″ can be monitored (if necessary) with a high degree of accuracy and in a relatively simple manner.

Though it is possible to provide a motion transmitting arrangement between the output shaft 12a of the motor 12 and the lever 10, 10′ or 10″, it is presently preferred to mount the lever directly on the output shaft 12a, i.e., to move the roller 8 along an arcuate path having its center of curvature on the axis of the shaft 12a. This contributes to simplicity and compactness of the improved apparatus. The lever can but need not extend at right angles to the axis of the output shaft 12a.

If the improved apparatus employs a curling tool (such as the tool 22 or 22′), the position of the curling tool relative to the adjacent portion of the running web 1 preferably changes jointly with and in dependency upon changes in the position of the deflecting roller 8. This simplifies the construction of the apparatus because a single motor (12) suffices to change the positions of the roller 8 and of the curling tool. Thus, the improved apparatus is provided with means to select any one of several desirable geometrical positions of the running web 1 and the edge (such as 22a or 22a′) of the tool (22 or 22′) relative to each other. Such ability of the curling tool to change its position and/or orientation relative to the adjacent portion of the running web is desirable and advantageous because optimal treatment of webs consisting of different materials necessitates or renders it advisable to select different positions and/or orientations of the curling tool.

German patent No. 24 21 394 A1 discloses the utilization of a curling tool which can turn about an axis. However, the axis does not coincide with the edge of the curling tool. Moreover, the curling tool which is disclosed in this reference does not cooperate with a dancer roller or floating roller corresponding to the deflecting roller 8 in the apparatus of the present invention in spite of the fact that the German reference discloses a curling roller.

It is also within the scope of our invention to segregate the curling tool from the floating roller and to fixedly mount it adjacent the path of the running web. The arrangement is or can be such that the edge of the curling tool is spaced apart from the path for the web when it is not called upon to carry out a curling operation.

The motor 12 is preferably designed primarily to exert torque while stalled or while rotating at a low speed. Motors of such character are distributed by the German Company AMK Arnold Müller GmbH & Co. KG, Gauss-Strasse 37-39, D-73230 Kirchheim/Teck, Federal Republic of Germany.

Regulators (20) which can be utilized in the apparatus of the present invention are distributed by Siemens AG, München, Federal Republic of Germany.

Without further analysis, the foregoing will so fully reveal the gist of the present invention that others can, by applying current knowledge, readily adapt it for various applications without omitting features that, from the standpoint of prior art, fairly constitute essential characteristics of the generic and specific aspects of the above outlined contribution to the art of manipulating running webs of paper or the like and, therefore, such adaptations should and are intended to be comprehended within the meaning and range of equivalence of the appended claims.

What is claimed is:

1. Apparatus for manipulating a running elongated web of flexible material, comprising:
means for advancing the web lengthwise in a predetermined direction along a predetermined path through a processing station;
means for deflecting successive increments of the advancing web at said station to a variable degree transversely of a portion of said path with attendant flexing of the web;
means for moving said deflecting means between a plurality of different positions, including means for applying to said deflecting means a variable force; and
means for maintaining said force at an at least substantially constant value irrespective of the position of said deflecting means.

2. The apparatus of claim 1, wherein the web consists of a wrapping material for smokers' products.

3. The apparatus of claim 1, wherein said moving means includes a regulatable motor and said means for maintaining said force includes means for regulating said motor to ensure that the magnitude of said force upon, and the position of, said deflecting means are variable independently of each other to at least approximate predetermined values.

4. The apparatus of claim 3 for manipulating a running web having randomly distributed irregularities, wherein said maintaining means further comprises sensor means adjacent said path and arranged to generate signals in response to detection of irregularities, said regulating means being operative to effect a reduction of said force in response to signals from said sensor means.

5. The apparatus of claim 4, wherein said regulating means regulating the position of said deflecting means is deactivatable when said reduction of said force occurs.

6. The apparatus of claim 3, wherein said advancing means includes at least one pair of variable-speed rolls defining for the running web a nip, said regulating means including means for regulating the speed of said rolls as a function of the position of said deflecting means.

7. The apparatus of claim 3, wherein said advancing means includes a first pair of advancing rolls defining for the web a nip upstream of said station and a second pair of advancing rolls defining for the web a nip downstream of said station, as seen in said directon, said first and second pairs of rolls being arranged to respectively advance the web at first and second speeds and said regulating means being arranged to vary the speed of at least one of said pairs of advancing rolls and hence the difference between the speeds of said first and second advancing rolls, as a function of changes in the position of said deflecting means.

8. The apparatus of claim 3, wherein said maintaining means includes means for establishing a reference value for the position of said deflecting means dependent on a status of operation of the apparatus.

9. The apparatus of claim 1, wherein said positions include at least one position in which said deflecting means applies to the advancing web a deflecting force which is at least close to zero.

10. The apparatus of claim 1, wherein said advancing means is arranged to advance the web at a plurality of speeds including zero speed and said different positions include an idle position in which the deflecting means is at least substantially disengaged from the web, said moving means including means for effecting a movement of said deflecting means to said idle position in response to each reduction of the speed of the web to said zero speed.

11. The apparatus of claim 10, wherein said moving means includes an electric motor and is designed to move said deflecting means to said idle position when said motor is disconnected from a source of electrical energy.

12. The apparatus of claim 1, wherein said moving means includes a torque generator arranged to transmit an at least substantially constant torque.

13. The apparatus of claim 12, wherein said torque generator includes a torque motor.

14. The apparatus of claim 1, wherein said deflecting means is movable along an arcuate path and said moving means includes a motor arranged to move said deflecting means along said arcuate path.

15. The apparatus of claim 14, wherein said motor includes an output element rotatable about a predetermined axis, said arcuate path having a center of curvature at least close to said axis.

16. The apparatus of claim 1, wherein said deflecting means includes an idler roller and said moving means includes a motor having a rotary output element and a support non-rotatably mounted on said output element and mounting said idler roller.

17. The apparatus of claim 16, wherein said support includes a lever having a first end portion affixed to said output element and a second end portion remote from said output element and rotatably mounting said roller.

18. The apparatus of claim 17, wherein said lever extends at least substantially radially of said output element.

19. The apparatus of claim 1, further comprising a curling tool having an edge extending transversely of said path and arranged to contact one side of the web at said station.

20. The apparatus of claim 19, wherein said curling tool is arranged to contact the web upstream of said deflecting means, as seen in said direction.

21. The apparatus of claim 19, wherein said curling tool is arranged to contact the web downstream of said deflecting means, as seen in said direction.

22. The apparatus of claim 19, wherein said curling tool is operatively connected to and is movable by said moving means in synchronism with said deflecting means.

23. The apparatus of claim 22, wherein said positions of said deflecting means include at least one position in which said deflecting means applies to the advancing web a deflecting force which is at least close to zero, said curling tool being out of contact with the web in said at least one position of said deflecting means.

24. The apparatus of claim 19, wherein said deflecting means is movable relative to the web along an arcuate path and said moving means includes a motor having an output element turnable about a predetermined axis and a support mounted on said output element and carrying said deflecting means as well as said curling tool.

25. The apparatus of claim 24, wherein said curling tool has an axis at least substantially coinciding with said predetermined axis.

26. The apparatus of claim 24, wherein said edge of said tool at least substantially coincides with said axis.

27. The apparatus of claim 24, wherein said curling tool is non-rotatably borne by said support.

28. The apparatus of claim 27, wherein said support includes a portion remote from said deflecting means and non-rotatably mounting said curling tool.

29. The apparatus of claim 19, wherein said curling tool is separate from said support and/or stationary and said moving means is arranged to move said deflecting means relative to said curling tool.

30. The apparatus of claim 1, further comprising calibratable means for monitoring the positions of said deflecting means, said means for maintaining said force at said at least substantially constant value including means for calibrating said monitoring means and said calibrating means including means for effecting movements of the deflecting means between a first position of disengagement from the running web and a second position of maximum deflection of the web.

31. A method of regulating the tensioning of a running elongated web of flexible material, comprising the steps of:
advancing the web lengthwise in a predetermined direction along a predetermined path;
moving successive increments of the running web to a variable degree transversely of a portion of said path with attendant flexing and tensioning of the web, including applying to the web a force acting upon one side of the web; and
maintaining said force at an at least substantially constant value irrespective of the extent of movement of said increments away from said portion of said path.
